(19) United States
(12) Patent Application Publication
(10) Pub. No.: US 2015/0074652 A1
(43) Pub. Date: Mar. 12, 2015

(54) AVOIDING SIMILAR COUNTER-EXAMPLES IN MODEL CHECKING

(71) Applicant: International Business Machines Corporation, Armonk, NY (US)

(72) Inventors: HANA CHOCKLER, Haifa (IL); ODED MARGALIT, Haifa (IL); DMITRY PIDAN, Netanya (IL); SITVANIT RUAH, Rehovot (IL)

(73) Assignee: International Business Machines Corporation, Armonk, NY (US)

(21) Appl. No.: 14/022,239

(22) Filed: Sep. 10, 2013

(51) Int. Cl. G06F 11/36

(52) U.S. Cl. CPC G06F 11/3608
USPC 717/126

(57) ABSTRACT

A method, apparatus, and product for avoiding similar counter-examples in model checking. One method comprises model checking of a program by traversing control flow paths of the program to determine states associated with execution of the program, each state comprises at least symbolic values of variables; said traversing is biased to give preference to traversing control flow paths that are substantially different than control flow paths associated with traces of the program; whereby said model checking is guided away from executions that are similar to the traces. A second method comprises obtaining a counter-example produced by a model checker, computing a distance between a control flow path of the counter-example and between a set of one or more control flow paths of additional counter-examples; and in response to the distance being below a threshold, dropping the counter-example.

### TECHNICAL FIELD

The present disclosure relates to verification in general, and to model checking, in particular.

### BACKGROUND

Various methods and tools are known in the art for performing verification of computer programs. Some methods and tools use model checking, which defines a model of the program and verifies specification properties with respect to the model.

Concolic verification tools are tools which use a combination of both concrete values and symbolic values. One example of a concolic verification tool is a concolic model checker such as described in U.S. Pat. No. 8,209,667 entitled “Software verification using hybrid explicit and symbolic model checking” by Eisner et al, which is hereby incorporated by reference in its entirety.

A model checker is often configured to provide a trace, also referred to as a counter-example, exemplifying any violation of a specification property. The counter-example may be, for example, a log of an execution of the program which results in a state which violates the specification property.

In some cases, the specification property is defined by an assertion statement within the program. The assertion statement may be any command which defines an inherent predicate to be held, such as index within a bound (e.g., inherent to access of an array), division by non-zero value (e.g., inherent to a division by a variable), access to a valid address location (e.g., inherent to pointer dereferencing), or the like. Additionally or alternatively, the assertion statement may be an assertion command such as “assert(P)”, which explicitly requires that the predicate P be held. Upon reaching the assertion statement, the model checker may check if the state holds the predicate.

### BRIEF SUMMARY

One exemplary embodiment of the disclosed subject matter is a computer-implemented method comprising: performing, by a processor, model checking of a computer program, wherein the model checking comprises traversing control flow paths in a Control Flow Graph (CFG) of the computer program to determine states associated with execution of the computer program along control flow paths in the CFG, wherein each state comprises at least symbolic values of variables; wherein said traversing is biased to give preference to traversing control flow paths that are substantially different than one or more control flow paths associated with traces of the computer program; and whereby said model checking is guided away from executions that are similar to the traces.

Another exemplary embodiment of the disclosed subject matter is a computer-implemented method comprising: obtaining a counter-example produced by a model checker with respect to a computer program, wherein the model checker is configured to traverse control flow paths in a Control Flow Graph (CFG) of the computer program to determine states associated with execution of the computer program along control flow paths in the CFG, wherein each state comprises at least symbolic values of variables; computing, by a processor, a distance between a control flow path of the counter-example and between a set of one or more control flow paths of additional counter-examples; and in response to the distance being below a threshold, dropping the counter-example without reporting the counter-example to a user; whereby the counter-example is not reported to the user in view of another counter-example which is deemed similar to the counter-example.

Yet another exemplary embodiment of the disclosed subject matter is a computerized apparatus having a processor, the processor being adapted to perform the steps of: performing model checking of a computer program, wherein the model checking comprises traversing control flow paths in a Control Flow Graph (CFG) of the computer program to determine states associated with execution of the computer program along control flow paths in the CFG, wherein each state comprises at least symbolic values of variables; wherein said traversing is biased to give preference to traversing control flow paths that are substantially different than one or more control flow paths associated with traces of the computer program; and whereby said model checking is guided away from executions that are similar to the traces.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a flowchart diagram of a method, in accordance with some exemplary embodiments of the disclosed subject matter;

FIG. 1B shows a flowchart diagram of a method, in accordance with some exemplary embodiments of the disclosed subject matter;

FIG. 2A shows an illustration of a control flow graph of a program, in accordance with some exemplary embodiments of the disclosed subject matter;

FIG. 2B-2D show illustrations of a control flow paths, in accordance with some exemplary embodiments of the disclosed subject matter;

FIG. 3 shows a block diagram of an apparatus, in accordance with some exemplary embodiments of the disclosed subject matter; and

FIG. 4 shows a flowchart diagram of a method, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to guide model checking of a computer program. Another technical problem is to find different counter-examples to counter-examples that were already found in the computer program. Yet another technical problem is to avoid reporting a counter-example that is different than previously reported counter-examples but originates from similar or same cause.

Symbolic model checkers that traverse a Control Flow Graph (CFG) of a computer program may utilize symbolic values to represent the data of the computer program (e.g., values of variables of the computer program) while explicitly representing meta-data which relates to the “control” aspect of the computer program (e.g., program counter, instruction pointer, or the like). Such model checkers may treat each control flow path, also referred to as a Control Path (CP), as a representation of a group of different executions that follow the CP. Hence, using symbolic representation of the data, the model checker may determine if specification properties are held by the group of different executions. In some exemplary embodiments, the model checker may so determine using a theorem prover, a Boolean Satisfiability Problem (SAT) solver, a Constraint Satisfaction Problem (CSP) solver, or the like.

The model checker may report a counter-example upon identifying a state which violates a specification property. The counter-example may indicate the CP followed by a violating execution and also indicate values of the variables. In some cases, the same cause of an error may be revealed by a plurality of counter-examples, each of which relates to an execution that follows a different CP. As an example, the CP may differ in a non-significant manner in the beginning of the execution (e.g., a different branch is taken during initialization), which would not be relevant to the violation of the specification property. Hence, though the model checker may treat the two counter-examples as different, as it may identify them with different CPs, a user receiving report of these two counter-examples may find them to be duplicative.

In some exemplary embodiments, Model checking of software system may be viewed as a non-complete solution in view of the size of the state-space of such a system. Model checkers for software may be viewed as “bug hunters”—that is, they search for bugs in software as efficiently as possible. Hence, in some cases, it may be desired to guide the model checker to traverse CPs that are substantially different than CPs of known counter-examples (CEs) so as to not waste resources on reporting to the user CEs that are deemed as redundant as the exemplify the same bug which was exemplified in a previous CE.

One technical solution is to guide the CFG traversal of the model checker so as to give preference to traversing CPs that are different than CPs of known CEs.

In some exemplary embodiments, a distance function is used to compute a distance between a first CP and a second CP, wherein short distance may be indicative of similarity between the two CPs. In some exemplary embodiments, if the distance is below a threshold the two CPs may be considered similar. In some exemplary embodiments, if the distance is above a second threshold, the two CPs may be considered completely dissimilar. In some exemplary embodiments, the similarity threshold and the dissimilarity threshold may be the same or may be different (e.g., similarity threshold<dissimilarity threshold).

In some exemplary embodiments, the model checker may be configured to prioritize the states based on the distance between their CP and the CPs of CEs, so as to give higher priorities to states which relate to CPs that are different than the CPs of CEs.

In some exemplary embodiments, ant search traversal may be employed. During ant search traversal, branches of the CFG are traversed in an order that is affected by the last time during which CEs were found in the branch. Once a edge was used to find a bug, the edge is marked with a fading mark. The mark fades in time. The ant search traversal priorities traversing non-marked edges. Hence, when facing two outgoing edges, the ant search traversal may prefer the edge in which a CE was not found or was found in a more distant time.

Another technical solution is to obtain two or more CEs from a model checker and show only a portion thereof to the user. The portion may exclude CEs which are considered similar to at least one CE in the portion.

One technical effect of the disclosed subject matter is to reduce redundant resources utilized by the model checker to find CEs that are similar to CEs already found. Another technical effect is to increase the probability of finding a variety of different bugs at an earlier state of examination. Yet another technical is to reduce duplicative data presented to the user, thereby increasing the user's attention to each CE reported to the user.

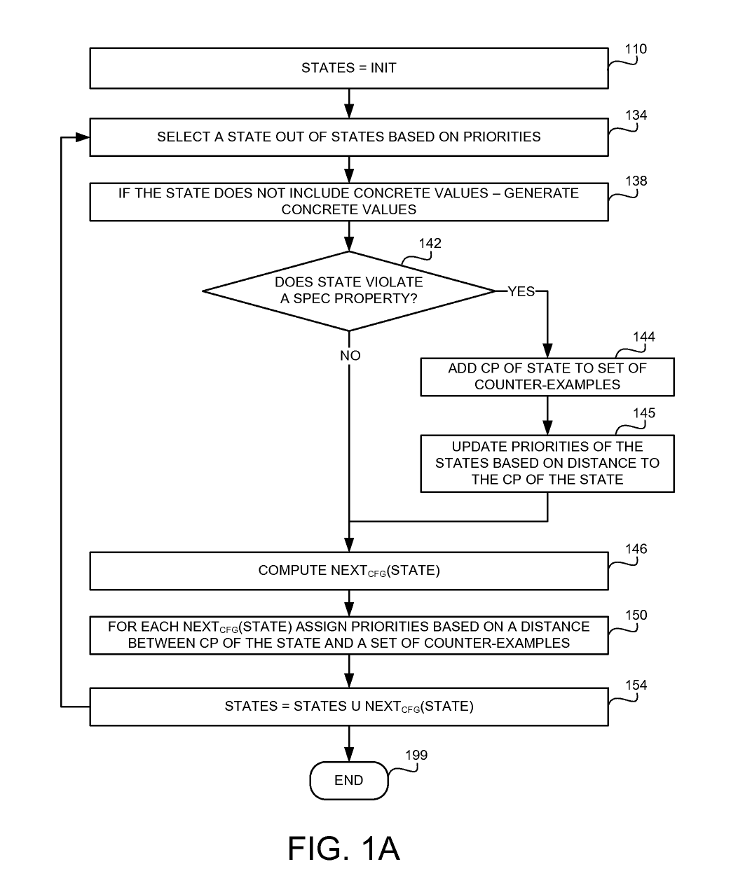

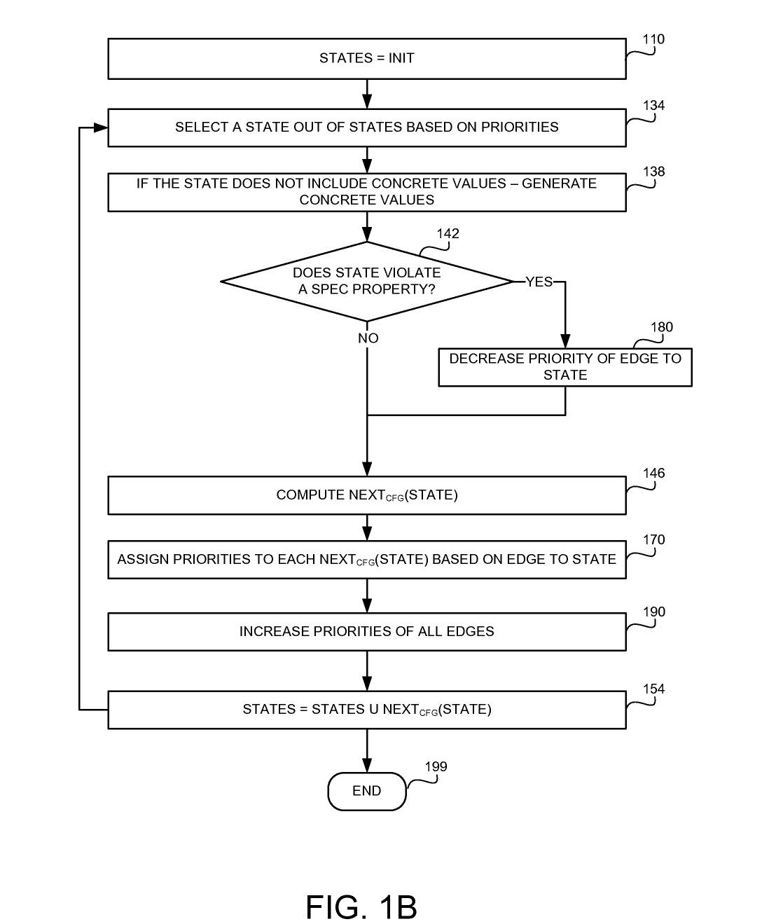

Referring now to FIG. 1A showing a flowchart diagram of a method, in accordance with some exemplary embodiments of the disclosed subject matter.

In Step 110, a set of states to be traversed is initialized, such as using one or more initial states of the program. The states may define a location in the CFG of the program (e.g., value of an instruction pointer) and symbolic value of variables of the program. Additionally or alternatively, the states may also define a concrete value of the variables in addition to the symbolic value. In some exemplary embodiments, the state may indicate the CP followed thus far in reach the state (e.g., either explicitly or in another non-explicit manner).

In Step 134, a state is selected from the set of states based on the priorities. The selected state may be removed from the set of states. In some exemplary embodiments, the set of states may be a heap, a priority queue or a similar data structure useful for selecting items having higher priorities. In some exemplary embodiments, the selection may be stochastically biased to give preference to states having higher priorities but not guaranteeing such a selection.

In Step 138, if the state does not include concrete values, such values may be generated based on the symbolic value of the variables, as defined in the state. In some exemplary embodiments, the concrete values may be generated using a theorem prover, a Boolean satisfiability problem (SAT) solver, a Constraint Satisfaction Problem (CSP) solver, or the like, which may be used to determine a concrete value that would satisfy the symbolic value and optionally a path condition of the state. The path condition may indicate a constraint over the variables of the program that only if held, the execution follows a specific CP. Each state may include a path condition based on the CP that was traversed from the init state until the state.

In some exemplary embodiments, if the state is not reachable (e.g., path condition is unsatisfiable), the state may be dropped and State 134 may be performed.

In Step 142, the state may be checked for a violation of a specification property. The specification property may be defined by the statement to be executed, either inherently or explicitly. Additionally or alternatively, the specification property may be defined manually over all the states of the computer program, such as a safety property defined using a property specification language such as PSL.

In some exemplary embodiments, the violation of the specification property may be determined using the symbolic values of the state, thereby checking for violation by any execution that would follow the CP associated with the state.

In the absence of a violation, Step 146 is performed. In Step 146, one or more next states are determined based on the CFG. A next state of a state may be a state that is associated to a node that is reachable via exactly one edge from the node of the CFG of the state. In some exemplary embodiments, a state may have two or more next states in case of a junction in the CFG. The concrete value of the state may dictate a next state, such as in case of a junction that originates from an IF statement over a predicate having a value defined by the concrete values of the state. In such a case, the concrete values of the next state may be defined based on the concrete values of the state. However, the concrete value of the alternative next states may not be known (and thus may be generated in Step 138 once such a state is selected). Additionally or alternatively, the selection between the junctions may be non-deterministic, such as in case of a junction that is due to concurrency. In such a cases, the concrete value the next states may be defined based on the concrete values of the state.

In Step 150, each next state is assigned a priority. The priority may be based on a distance between CP of the state and CPs of a set of CEs.

In some exemplary embodiments, the distance may be computed using a distance function that is used to measure similarity between to CPs.

In some exemplary embodiments, the distance function may be a norm of the edit distance vector. The edit distance vector between two CPs may be defined as the length of the changes (addition/deletion/modification) needed to make one CP be the same as the second one.

In some exemplary embodiments, the norm may be an L1 norm (sum of the length of each addition/deletion/change). L1 norm may consider two versions that differ in a single branch outcome as the same distance of two other that differ in two different branches as long as the number of statements that are performed in each option of the branch (e.g., the number of instructions in the “then” and “else” sections of an if-then-else statement) is the same. Additionally or alternatively, an L2 norm may be used. L2 norm is the square root of the sum of the squares of the differences. L2 norm may account for the size of the portions of the two branches as opposed to the L1 norm: in comparing a difference in a single branch which is twice as long as two different branches it regards the former as farther apart than the later.

Consider the following three CPs: the first CP is 1→2→3→4→5, the second CP is 1→2′→3→4′→5 and the third CP is 1→2′→3′→4→5. Distance between the first and second CPs based on a L1 norm of the edit vector may be 2. The distance between o the first and third CPs based on L1 norm of the edit vector is also 2. However, in some exemplary embodiments, the third CP may be considered as less similar to the first CP than the second CP in view of a larger sub-path in which the two CPs differ. Computing the distance using L2 based norm provides such a result as the distance between the first and second CPs would be sqrt(2) while the distance between the first and third CPs would be 2. Thus, the L2 norm may be useful to allow the disclosed subject matter to be more sensitive to different kind of changes in the path.

In some exemplary embodiments, the distance function may be weighted also to take into consideration assertion statements in the CP. Two CPs that differ in an assertion statement may be considered more dissimilar than two CPs that instead differ in a non-assertion statement. Such a distance function may be useful as it may be used to differentiate between similar CEs that “fall” due to the same assertion statement. In some exemplary embodiments, the distance function may only consider whether or not the last nodes are associated with the same assertion statements.

In some exemplary embodiments, the set of CEs may include a plurality of CEs, each of which associated with a different CP (e.g., CP₁ . . . CPₙ). The distance between the CP and the set of CEs may be computed as the shortest distance between the CP and a member of the set (i.e., min{dis(CP,CPᵢ)}). This may allow to find a new “bug” which is farthest from the set of all previously discovered bugs.

In Step 154, the computed next states are added to the set of states. In some exemplary embodiments, states are only added if they were not previously traversed. Such a determination may be performed using a history mechanism of the traversed states.

If the set of states is not empty, step 134 may be performed. Otherwise, the method may end in Step 199 as the traversal of the CFG is completed.

In case a state that violates a specification property is found in Step 142, Step 144 may be performed. In Step 144, a new CE may be generated based on the state. A CP that was followed along the CFG in order to reach the state may be added to a set of CPs of CEs. That CP may be used from now on to guide the CFG traversal to different CPs.

In Step 145, the priorities of states in the set of states may be updated. In some exemplary embodiments, for each state the computed distance may be stored and upon performing Step 145, the distance between its CP and the CP of the new CE may be computed. In case the distance is shorter than indicated in the state, the priority of the state may be updated accordingly.

Upon performing Step 150, priorities of the new states may be determined based on (also) the similarity to the new CE (e.g., similarity in the control paths).

Referring now to FIG. 1B, showing a flowchart diagram of a method that employs ant search, in accordance with some exemplary embodiments of the disclosed subject matter.

All edges may be marked with a maximal priority (e.g., one hundred 100). The priority of an edge that is traversed may be used to determine the priority of the state (Step 170). In other words, when an edge is traversed to reach a new state, the priority of the state is based on the priority of the edge at that time.

In Step 180, during traversal of the CFG, upon reaching a specification violation, the edge of the CFG that was used to reach the state may be marked with a most reduced priority, such as for example marked by the value zero (0). In some exemplary embodiments, all the edges that were taken in the CFG to reach the state (e.g., all edges in the CP) may be marked accordingly.

In Step 190, after traversing a state, all priorities of all the edges may be increased. In some exemplary embodiments, the maximal priority cannot be increased. Hence, the priorities at the edges of the CFG are indicative of the locations where CEs were found most recently. The incrimination of the priority is used as to “fade” the minimal priority if new CEs were not found recently. As can be appreciated, the incrimination may be performed after traversing a state, after traversing a predetermined number of states, or the like. Additionally or alternatively, the number of incriminations that would clear the “mark” on the edge (e.g., the number of incriminations needed to change from the reduced priority to the maximal priority) may differ from one embodiment to another and may be any positive number.

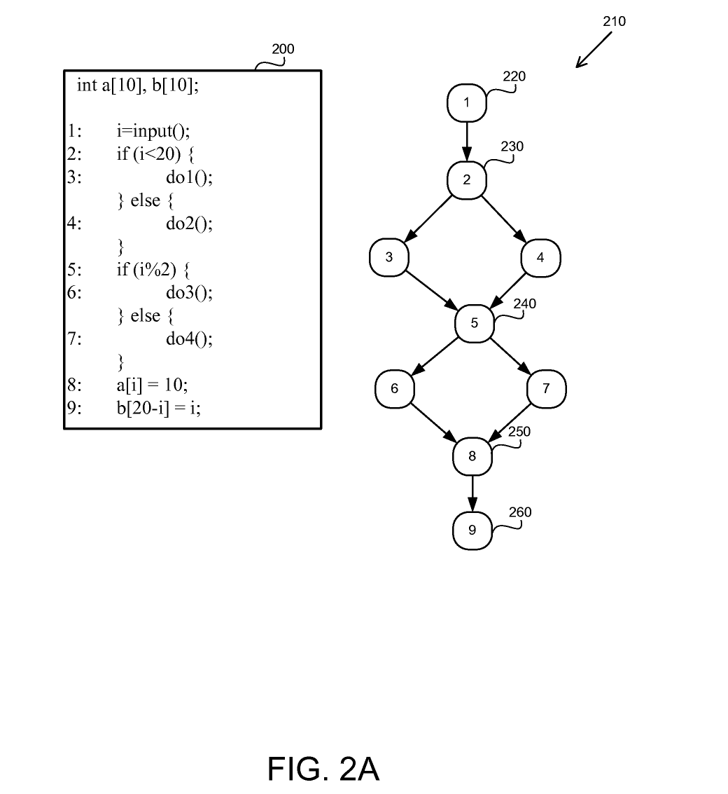

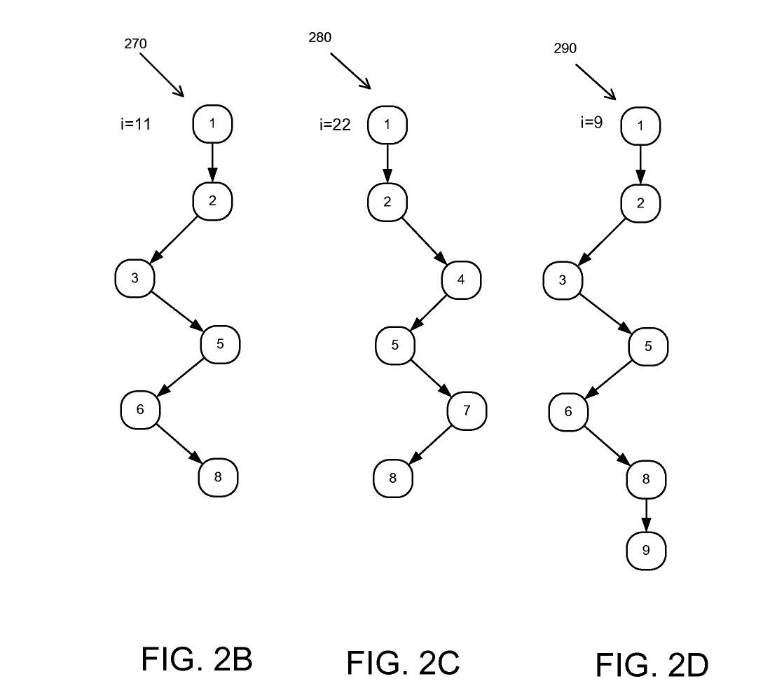

Reference is now made to FIG. 2A which shows an illustration of a CFG of a program, in accordance with some exemplary embodiments of the disclosed subject matter. CFG 210 of Program 200 represents each line of code in Program 200 (denoted with a number) with a node (that is denoted using the same number). For example, Node 220 corresponds to the statement “i=input( )”.

A node associated with a branching statement, such as Node 230 which corresponds to “if (i<20)”, may be associated with two or more successor nodes. Similarly, Node 240 is also associated with two or more

The statement “a[i]=10” may be an assertion statement as it inherently defines a constraint over the value of i (0≦i<10). Hence, Node 250 is associated with an assertion statement. Similarly, Node 260 is also associated with an assertion statement as it requires: 0≦20−i<10.

FIGS. 2B-2D show different control paths in CFG 210. CP 270 is a CP that is followed, for example, if the value of variable i is set to 11 in Node 220. CP 280 is a CP that is followed, for example, if the value of variable i is set to 22 in Node 220, while CP 290 represents the CP that would be followed when the value of i is set to 9.

As can be appreciated, though CP 270 and CP 280 differ in every branching decision, they still represent a similar bug—failing to satisfy the assertion of Node 250 as the value of i is greater than nine (9). Hence, in this case, a distance function based on an L1 norm of the edit vector between CP 270 and CP 280 may result in a relatively large distance. However, they still represent the same bug. In some exemplary embodiments, the distance function may, therefore, take into consideration the fact that both CPs represent a failure of the same assertion statement, though it was reached via different paths.

In this specific example, CP 270 and CP 290 may be considered as having a relatively shorter distance than that between CP 270 and CP 280 based on the L1 norm of the edit vector. However, CP 290 represents a different bug (20−i not being below 10), as it stems from a different assertion statement.

As can be appreciated from Program 200 of FIG. 2A and its various CP of CEs shown in FIGS. 2B-2D, the distance function that is being used may be of importance. L1 norm based distance may be useful, at its core, in order to differentiate between CPs. However, in some cases, CPs that are deemed distant according to such a distance function may represent the same bug. For this reason, the disclosed subject matter provides for other distance functions, such as relating to dissimilarity in ancestors and to the assertion statements. However, additional distance functions may be utilized in order to identify different CPs that relate to CEs which exemplify the same bug in the computer program.

In some exemplary embodiments, ancestor distance may be used. Ancestor distance may be defined as the sum of the length of the paths minus the length of the common sub-path from the beginning of the program till the first different branch. As an example, in accordance with ancestor distance, A→B→C→x→D→E→F→G may be considered closer to A→B→C→D→E→F→G than x→A→B→C→D→E→F→G. Ancestor distance may be useful in finding counter-examples that split from previously discovered counter-examples as early as possible.

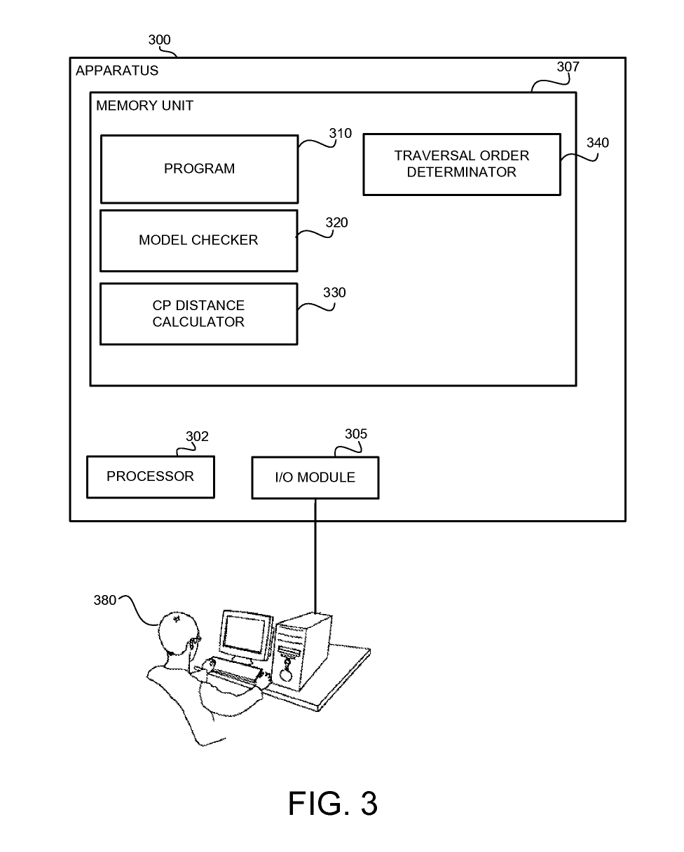

Referring now to FIG. 3 showing a block diagram of components of an apparatus, in accordance with some exemplary embodiments of the disclosed subject matter. An apparatus 300 may be a computerized apparatus adapted to perform methods such as depicted in FIGS. 1A-1B.

In some exemplary embodiments, Apparatus 300 may comprise a Processor 302. Processor 302 may be a Central Processing Unit (CPU), a microprocessor, an electronic circuit, an Integrated Circuit (IC) or the like. Alternatively, Apparatus 300 can be implemented as firmware written for or ported to a specific processor such as Digital Signal Processor (DSP) or microcontrollers, or can be implemented as hardware or configurable hardware such as field programmable gate array (FPGA) or application specific integrated circuit (ASIC). Processor 302 may be utilized to perform computations required by Apparatus 300 or any of it subcomponents.

In some exemplary embodiments of the disclosed subject matter, Apparatus 300 may comprise an Input/Output (I/O) Module 305 such as a terminal, a display, a keyboard, an input device or the like to interact with the system, to invoke the system and to receive results. It will however be appreciated that the system can operate without human operation.

In some exemplary embodiments, the I/O Module 305 may be utilized to provide an interface to a User 380 to interact with Apparatus 300, such as to provide the detected bugs to User 380, to report CEs to User 380, or the like.

In some exemplary embodiments, Apparatus 300 may comprise a Memory

Unit 307. Memory Unit 307 may be persistent or volatile. For example, Memory Unit 307 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory Unit 307 may retain program code operative to cause Processor 302 to perform acts associated with any of the steps shown in FIGS. 1A-1B.

The components detailed below may be implemented as one or more sets of interrelated computer instructions, executed for example by Processor 302 or by another processor. The components may be arranged as one or more executable files, dynamic libraries, static libraries, methods, functions, services, or the like, programmed in any programming language and under any computing environment.

A Program 310 may be the program being verified. In some exemplary embodiments, a code of Program 310 may be provided.

A Model Checker 320 may be configured to model check a target program, such as Program 310, to detect bugs or other violations of specification properties. Model Checker 320 may be a symbolic model checker representing a set of states together using symbolic values. Model Checker 320 may be configured to traverse a CFG of the target program. In some exemplary embodiments, Model Checker 320 may be a concolic Model Checker 320.

A CP Distance Calculator 330 may be configured to compute a distance between a CP and a set of one or more CPs. The computed distance may be based on the minimal computed distance between the CP and each member of the set of CPs. The distance may be computed using a distance function such as based on a norm of an edit vector, hamming distance, an ancestor distance, or the like. The distance may give higher weight to similarity in the final node, so as to deem CEs that reach an assertion violation in the same node as having a higher degree of similarity.

Model Checker 320 may utilize a Traversal Order Determinator (TOD) 340 to determine an order of traversal of the CFG. In some exemplary embodiments, TOD 340 may be configured to set priorities to states based on the CFG traversal order.

In some exemplary embodiments, TOD 340 may employ an ant search traversal order. In some exemplary embodiments, TOD 340 may utilize CP Distance Calculator 330 in order to determine an order of traversal by biasing the traversal order towards traversing CPs that are substantially different than CPs of CEs previously identified by Model Checker 320.

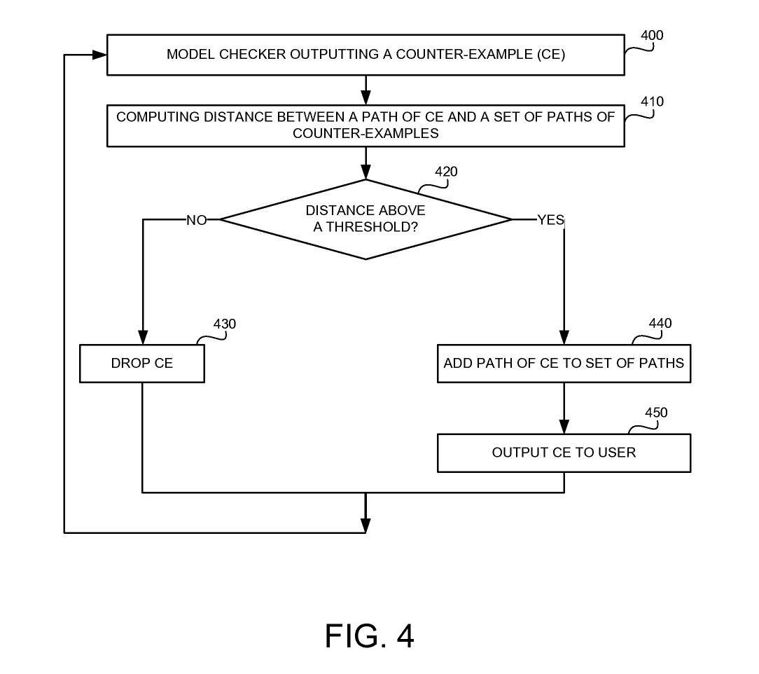

Referring now to FIG. 4 showing a flowchart diagram of a method, in accordance with some exemplary embodiments of the disclosed subject matter.

In Step 400, a model checker, such as 320 of FIG. 3, outputs a CE

In Step 410, a distance between the CP of the CE and a set of CPs of CEs is computed. The distance may be computed using any distance function, such as but not limited to norm of an edit vector, ancestor distance, assertion-statement oriented distance function, or the like. In some exemplary embodiments, the computed distance from the set may be computed as the minimal distance from any member of the set.

In Step 420, the computed distance is compared to a threshold, which may be predetermined In case the distance is below a threshold, the CE may be deemed as similar to the CEs. Hence, and as the CEs were previously reported to the user, the CE may be dropped (Step 430).

Alternatively, if the distance is above the threshold, the CE may be deemed different than previously reported CEs. The CE may be reported to the user (Step 450) and the CP of the CE may be added to the set of CPs (Step 440). The addition of the CP may be aimed to allow the CP to be used to filter out new CEs that may be obtained in the future and may be similar to the CE.

In some exemplary embodiments, CEs that are considered similar may be grouped together and a single CE may be outputted to the user to represent the group. FIG. 4 exemplifies that the CE of each such group that was first found by the model checker is the reported CE. However, in some embodiments, the group of CEs may be collected and selection of the CE to report may be based on different criteria than the order in which the model checker generates the CEs. One example of a different criterion that may be to report the CE having the shortest CP. Other criteria may be used as well.

The flowchart and block diagrams in the Figures illustrate the architecture, functionality, and operation of possible implementations of systems, methods and computer program products according to various embodiments of the present invention.

In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, an and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
performing, by a processor, model checking of a computer program, wherein the model checking comprises traversing control flow paths in a Control Flow Graph (CFG) of the computer program to determine states associated with execution of the computer program along control flow paths in the CFG, wherein each state comprises at least symbolic values of variables;
wherein said traversing is biased to give preference to traversing control flow paths that are substantially different than one or more control flow paths associated with traces of the computer program; and
whereby said model checking is guided away from executions that are similar to the traces.

2. The computer-implemented method of claim 1, wherein said traversing is based on priorities of the states, wherein a state is given a priority based on a computed distance between the control flow path of the state and the one or more control flow paths associated with the traces.

3. The computer-implemented method of claim 2, wherein the computed distance is computed using a distance function, wherein the distance function is selected from the group consisting of a norm of an edit vector, and an ancestor distance function.

4. The computer-implemented method of claim 2, wherein the computed distance is computed using a distance function which gives a higher weight to nodes associated with assertion statements, wherein during said traversal, in response to traversing a state associated with an assertion statement, said model checking verifies that the assertion statement is held by the symbolic values of the variables of the traversed state.

5. The computer-implemented method of claim 2, wherein a highest priority is given to each state for which the computed distance is above a predetermined threshold.

6. The computer-implemented method of claim 2, wherein the one or more control flow paths associated with the traces comprise at least two control flow paths, wherein the computed distance between the control flow path and the one or more control flow paths is a minimum of computed distances between the control flow path and each of the one or more control flow paths.

7. The computer-implemented method of claim 1, wherein the traces are associated with one or more counter-examples found during said model checking, wherein said traversing implements an ant search traversal that gives precedent to branches of the CFG in which a counter-example was not found within a recent frame.

8. The computer-implemented method of claim 1, wherein said traversing is performed non-deterministically with a stochastic biasing.

9. The computer-implemented method of claim 1, wherein said model checking is concolic model checking, wherein the states further include concrete values of variables.

10. The computer-implemented method of claim 1, wherein the traces are counter-examples, each of which exemplifies a violation of a specification property by the computer program, wherein the counter-examples are found during said model checking.

11. A computer-implemented method comprising:
obtaining a counter-example produced by a model checker with respect to a computer program, wherein the model checker is configured to traverse control flow paths in a Control Flow Graph (CFG) of the computer program to determine states associated with execution of the computer program along control flow paths in the CFG, wherein each state comprises at least symbolic values of variables;
computing, by a processor, a distance between a control flow path of the counter-example and between a set of one or more control flow paths of additional counter-examples; and
in response to the distance being below a threshold, dropping the counter-example without reporting the counter-example to a user;
whereby the counter-example is not reported to the user in view of another counter-example which is deemed similar to the counter-example.

12. The computer-implemented method of claim 11, further comprising in response to the distance being above the threshold, reporting the counter-example to the user and adding the control flow path of the counter-example to the set of one or more control flow paths.

13. The computer-implemented method of claim 11, wherein the additional counter-examples are obtained from the model checker prior to obtaining the counter-example; and wherein each control flow path of an additional counter-example is characterized in having a distance from control flow paths of each of the other additional counter-examples, that is above the threshold.

14. A computerized apparatus having a processor, the processor being adapted to perform the steps of:
performing model checking of a computer program, wherein the model checking comprises traversing control flow paths in a Control Flow Graph (CFG) of the computer program to determine states associated with execution of the computer program along control flow paths in the CFG, wherein each state comprises at least symbolic values of variables;
wherein said traversing is biased to give preference to traversing control flow paths that are substantially different than one or more control flow paths associated with traces of the computer program; and
whereby said model checking is guided away from executions that are similar to the traces.

15. The computerized apparatus of claim 14, wherein said traversing is based on priorities of the states, wherein a state is given a priority based on a computed distance between the control flow path of the state and the one or more control flow paths associated with the traces.

16. The computerized apparatus of claim 15, wherein the computed distance is computed using a distance function, wherein the distance function is selected from the group consisting of a norm of an edit vector, and an ancestor distance function.

17. The computerized apparatus of claim 15, wherein the computed distance is computed using a distance function which gives a higher weight to nodes associated with assertion statements, wherein during said traversal, in response to traversing a state associated with an assertion statement, said model checking verifies that the assertion statement is held by the symbolic values of the variables of the traversed state.

18. The computerized apparatus of claim 15, wherein the one or more control flow paths associated with the traces comprise at least two control flow paths, wherein the computed distance between the control flow path and the one or more control flow paths is a minimum of computed distances between the control flow path and each of the one or more control flow paths.

19. The computerized apparatus of claim 14, wherein the traces are associated with one or more counter-examples found during said model checking, wherein said traversing implements an ant search traversal that gives precedent to branches of the CFG in which a counter-example was not found within a recent frame.

20. The computerized apparatus of claim 14, wherein the traces are counter-examples, each of which exemplifies a violation of a specification property by the computer program, wherein the counter-examples are found during said model checking.
